(19) United States
(12) Patent Application Publication
(10) Pub. No.: US 2015/0156771 A1
(43) Pub. Date: Jun. 4, 2015

(54) COMMUNICATION METHOD AND COMMUNICATION DEVICE FOR SUPPORTING A PLURALITY OF BASIC BANDWIDTH MODES IN WIRELESS LAN SYSTEM THAT SUPPORTS MULTIPLE BANDWIDTHS

(71) Applicant: Electronics and Telecommunications Research Institute, Daejeon (KR)

(72) Inventors: Hee Jung Yu, Daejeon (KR); Min Ho Cheong, Daejeon (KR); Jae Seung Lee, Daejeon (KR); Hyoung Jin Kwon, Daejeon (KR); Sok Kyu Lee, Daejeon (KR)

(21) Appl. No.: 14/412,668

(22) PCT Filed: Jul. 5, 2013
(86) PCT No.: PCT/KR2013/005996

§ 371 Date: Jan. 2, 2015

(30) Foreign Application Priority Data
Jul. 5, 2012 (KR) 10-2012-0073344
Jul. 5, 2013 (KR) 10-2013-0078797

(51) Int. Cl. H04W 72/04

(52) U.S. Cl. CPC H04W 72/0446; H04W 72/0453; H04W 84/12

(57) ABSTRACT

Provided is an apparatus and method for supporting a plurality of basic bandwidth modes in a wireless local area network (WLAN) system supporting a multi-bandwidth, wherein a communication method of an access point (AP) in a WLAN system includes verifying an operational status of a network by an AP included in the network supporting a first bandwidth and a second bandwidth two times greater than the first bandwidth, allocating a first time slot in which a transmission of a frame with at least the first bandwidth is allowed, based on the operational status of the network, and allocating a second time slot in which a transmission of a frame with at least the second bandwidth is allowed, based on the operational status of the network.

### TECHNICAL FIELD

The present invention relates to a method and apparatus for supporting a plurality of basic bandwidth modes in a wireless local area network (WLAN) system.

### BACKGROUND ART

In general, development of wireless local area network (WLAN) technology has advanced in three directions.

One direction indicates technology for improving a transmission rate and includes WLAN technology using a 60 gigahertz (GHz) band and WLAN technology using a 5 GHz band. Another direction indicates wideband WLAN technology using a frequency band under 1 GHz to extend coverage when compared to conventional WLAN technology, and still another direction indicates technology for reducing link set-up time of a WLAN system.

Wideband WLAN technology may support a multi-bandwidth. There is a desire for a support of a plurality of basic bandwidth modes that may cover an entire communication coverage range of an access point (AP) in a WLAN system supporting a multi-bandwidth.

### DISCLOSURE OF INVENTION

### Technical Goals

An aspect of the present invention provides a method of an access point (AP) supporting stations (STAs) with various bandwidths in a wireless local area network (WLAN) system including two basic bandwidth modes, each providing a different range of communication service.

### TECHNICAL SOLUTIONS

According to an aspect of the present invention, there is provided a communication method of an access point (AP) in a wireless local area network (WLAN), the method including verifying an operational status of a network by an AP included in the network supporting a first bandwidth and a second bandwidth two times greater than the first bandwidth, allocating a first time slot in which a transmission of a frame with at least the first bandwidth is allowed, based on the operational status of the network, and allocating a second time slot in which a transmission of a frame with at least the second bandwidth is allowed, based on the operational status of the network.

According to another aspect of the present invention, there is also provided a communication method of a station (STA) in a WLAN system, the method including receiving allocation of a first time slot in which a transmission of a frame with at least a first bandwidth is allowed, from an AP of a network supporting the first bandwidth and a second bandwidth two times greater than the first bandwidth, transmitting a frame in the first time slot using the first bandwidth, receiving, from the AP, allocation of a second time slot in which a transmission of a frame with at least the second bandwidth is allowed, and transmitting a frame in the second time slot using the second bandwidth.

The frame transmitted in the first time slot may correspond to a first basic frame using the first bandwidth or a duplication mode frame generated based on the first basic frame.

The frame transmitted in the second time slot may correspond to a second basic frame using the second bandwidth or a duplication mode frame generated based on the second basic frame.

According to still another aspect of the present invention, there is also provided an AP of a WLAN system including a network manager to verify an operational status of a network supporting a first bandwidth and a second bandwidth two times greater than the first bandwidth, a bandwidth mode controller to allocate a first time slot in which a transmission of a frame with at least the first bandwidth is allowed, and allocate a second time slot in which a transmission of a frame with at least the second bandwidth is allowed, based on the operational status of the network, and a transmitter to transmit a frame for providing notification of allocation of the first time slot and allocation of the second time slot.

According to yet another aspect of the present invention, there is also provided an STA of a WLAN system including a receiver to receive, from an AP, a control frame for allocating a first time slot in which a transmission of a frame with at least a first bandwidth is allowed, and a control frame for allocating a second time slot in which a transmission of a frame with at least a second bandwidth two times greater than the first bandwidth is allowed, a transmitter to transmit a frame in the first time slot using the first bandwidth, and transmit a frame in the second time slot using the second bandwidth, and a controller to control an operation mode of the transmitter based on the control frame.

### Advantageous Effects

A conventional wireless local area network (WLAN) system provides a single basic bandwidth of a multi-bandwidth. Thus, all beacons and requests to send (RTS)/clear to send (CTS) frames are transmitted using the single basic bandwidth so as to be received by stations (STAs).

According to example embodiments of the present invention, it is possible to effectively support a multi-bandwidth in a WLAN system including a plurality of basic bandwidths providing various ranges of communication service.

For example, according to example embodiments of the present invention, it is possible to use a 1 megahertz (MHz) bandwidth beacon in addition to a bandwidth of a 2 MHz beacon, and support an operational status of a network in various patterns.

### BRIEF DESCRIPTION OF DRAWINGS

FIG. 1 is a diagram illustrating a multi-bandwidth of a wideband wireless local area network (WLAN) system.

FIG. 2 is a diagram illustrating a network operation state in a WLAN system according to an embodiment of the present invention.

FIG. 3 is a flowchart illustrating a communication method of an access point (AP) in a WLAN system according to an embodiment of the present invention.

FIGS. 4 through 8 are diagrams illustrating various methods of allocating a plurality of basic bandwidths.

FIG. 9 is a flowchart illustrating a communication method of a station (STA) in a WLAN system according to an embodiment of the present invention.

FIG. 10 is a diagram illustrating a configuration of an AP in a WLAN system according to an embodiment of the present invention.

FIG. 11 is a diagram illustrating a configuration of an STA in a WLAN system according to an embodiment of the present invention.

FIG. 12 is a diagram illustrating a frame structure of a first bandwidth of a multi-bandwidth in a wideband WLAN system.

FIG. 13 is a diagram illustrating a frame structure of a second bandwidth of a multi-bandwidth in a wideband WLAN system.

FIG. 14, parts (a) and (b), illustrate an example of configuring a duplication mode frame according to an embodiment of the present invention.

FIG. 15, parts (a) and (b), illustrate an example of configuring a duplication mode frame according to another embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

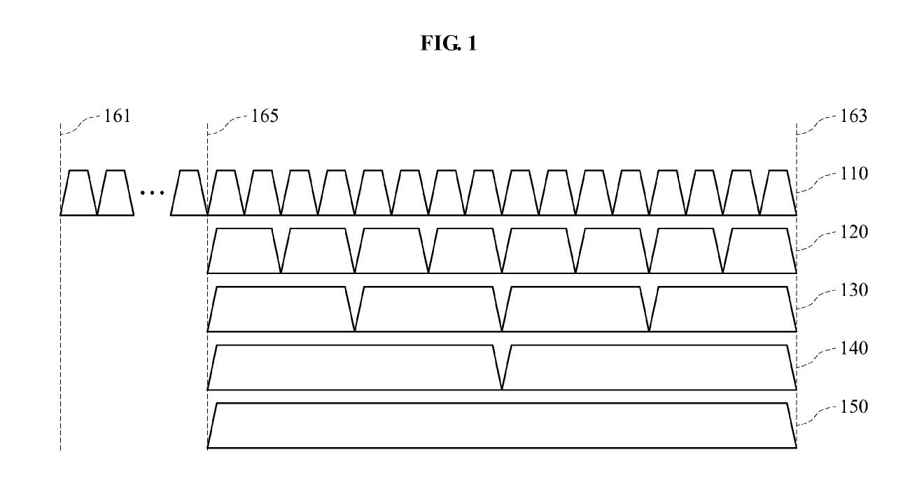

FIG. 1 is a diagram illustrating a multi-bandwidth of a wideband wireless local area network (WLAN) system.

A wideband WLAN system, for example, a WLAN system defined in the Institute of Electrical and Electronics Engineers (IEEE) 802.11ah standard, may support a multi-bandwidth. The multi-bandwidth may include a first bandwidth having the lowest signal-to-noise ratio (SNR) and a second bandwidth that is two times greater than the first bandwidth. In this instance, a value of the first bandwidth may be 1 megahertz (MHz).

In an environment in which a bandwidth of 1 megahertz (MHz) and at least a bandwidth of 2 MHz coexist, only 1 MHz of 2 MHz may be used. Since a relatively great amount of energy per bit of information is allocated to a 1 MHz bandwidth frame, the 1 MHz bandwidth frame may have a wide coverage whereas a 2 MHz bandwidth frame may have a relatively small coverage. However, in terms of transmitting the same amount of information, the 2 MHz bandwidth frame ensuring a transmission in a relatively short period of time may be preferentially used in a case related to throughput. Thus, when a beacon frame with the bandwidth of 1 MHz and a beacon frame with the bandwidth of 2 MHz are used in an appropriate combination, an efficient network operation may be performed based on a situation.

Referring to FIG. 1, the multi-bandwidth may include a bandwidth of 1 MHz 110, a bandwidth of 2 MHz 120, a bandwidth of 4 MHz 130, a bandwidth of 8 MHz 140, and a bandwidth of 16 MHz 150. A frequency band of the wideband WLAN system may be less than or equal to 1 gigahertz (GHz).

Accordingly, “the multi-bandwidth may be expressed to include 1 MHz, 2 MHz, 4 MHz, 8 MHz, and 16 MHz”.

In FIG. 1, a frequency lower limit value 161 may be a value between 700 MHz and 920 MHz, and a frequency upper limit value 163 may be a value between 750 MHz and 930 MHz.

As illustrated in FIG. 1, the bandwidth of 1 MHz 110 may be allocated throughout an entire channel, and remaining bandwidths, for example, the bandwidth of 2 MHz 120, the bandwidth of 4 MHz 130, the bandwidth of 8 MHz 140, and the bandwidth of 16 MHz 150 may be allocated to only a portion of a section of the entire channel.

For example, the bandwidth of 16 MHz 150 may be allocated between a predetermined frequency value 165 of FIG. 1 and the frequency upper limit value 163. Referring to FIG. 1, eight channels are allocated to the bandwidth of 2 MHz 120, four channels are allocated to the bandwidth of 4 MHz 130, and two channels are allocated to the bandwidth of 8 MHz 140. However, allocation of channels as illustrated in FIG. 1 is provided only as an example and thus, a number of channels and a frequency band may be configured using a variety of methods.

In the present specification, a transmission mode having a value of the bandwidth of 1 MHz 110 is referred to as a 1 MHz mode, and a transmission mode having a value of the bandwidth of 2 MHz 120 is referred to as a 2 MHz mode.

The 1 MHz mode may refer to a transmission mode that maintains an orthogonal frequency division multiplexing (OFDM) symbol structure and includes 32 subcarriers. In this instance, the 1 MHz mode may use a frequency domain repetition transmission method and thus, may have the lowest transmission rate among bandwidths. However, in the 1 MHz mode, a signal may be transmitted to the farthest distance since the 1 MHz mode has a low SNR.

In a wideband WLAN system using a frequency band less than 1 GHz, terminals receiving, in full, a signal transmitted in the 1 MHz mode and a signal transmitted in the 2 MHz mode may be necessary.

A WLAN technology using a 5 GHz band discloses a frame structure for dynamic bandwidth allocation. However, applying a packet structure of the WLAN technology using the 5 GHz band directly to the wideband WLAN system using the frequency band less than 1 GHz is difficult. Thus, a frame structure suitable for the frequency band less than 1 GHz is required.

When a current basic service set (BSS) supports the bandwidth of at least 2 MHz, use of the bandwidth of 1 MHz corresponding to one direction of the bandwidth of 2 MHz may be allowed. However, when the current BSS uses the bandwidth of 1 MHz, use of bandwidths of 1 MHz corresponding to both directions of the bandwidth of 2 MHz may be allowed.

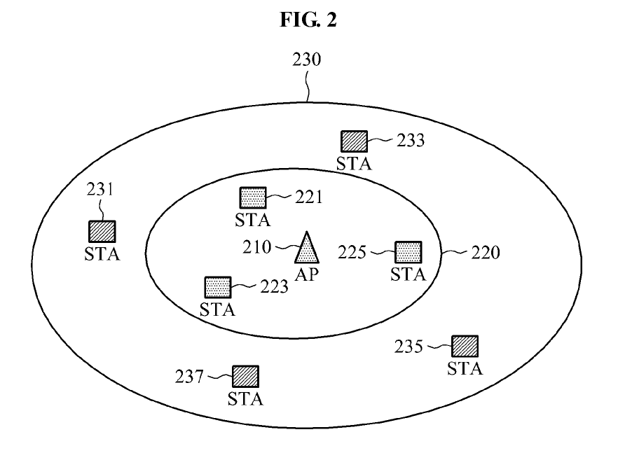

FIG. 2 is a diagram illustrating an operational status of a network in a WLAN system according to an embodiment of the present invention.

Referring to FIG. 2, for example, an access point (AP) 210 may transmit a beacon frame with a bandwidth of 1 MHz and a beacon frame with a bandwidth of 2 MHz, and stations (STAs) may receive the beacon frame in response thereto. Hereinafter, a station or a terminal may be referred to as an STA. In this instance, a reception state of STAs may vary based on a distance.

Communication coverage of the AP 210 may be divided into a first area 220 in which the beacon frame with the bandwidth of 1 MHz and the beacon frame with the bandwidth of 2 MHz are allowed to be received, and a second area 230 in which the beacon frame with the bandwidth of 1 MHz is allowed to be received.

For example, an STA 221, an STA 223, and an STA 225 included in the first area 220 may receive the beacon frame with the bandwidth of 1 MHz and the beacon frame with the bandwidth of 2 MHz.

In addition, an STA 231, an STA 233, an STA 235, and an STA 237 included in the second area 230 may receive the beacon frame with the bandwidth of 1 MHz.

Accordingly, when the AP 210 uses a beacon with the bandwidth of 2 MHz, overall network efficiency may increase while a coverage range of the AP 210 may decrease.

When the AP 210 continuously transmits the beacon frame with the bandwidth of 1 MHz to operate a network, various control frames including a beacon may be transmitted using a frame with the bandwidth of 1 MHz. Thus, relatively wide coverage may be supported, whereas an overall capacity deficiency issue may occur when an amount of data of STAs exceeds a capacity. Thus, a function of controlling a bandwidth of a beacon frame based on a network status may be required.

As described above, when STAs located in a surrounding area of a cell are allowed to use the frame with the bandwidth of 1 MHz, STAs located in a central area of the cell are allowed to use the frame with the bandwidth of 1 MHz, and the frame with the bandwidth of 2 MHz coexist, a scheme for setting a time slot for transmitting the frame with the bandwidth of 2 MHz and disallowing transmission and reception of the frame with the bandwidth of 1 MHz may be adopted.

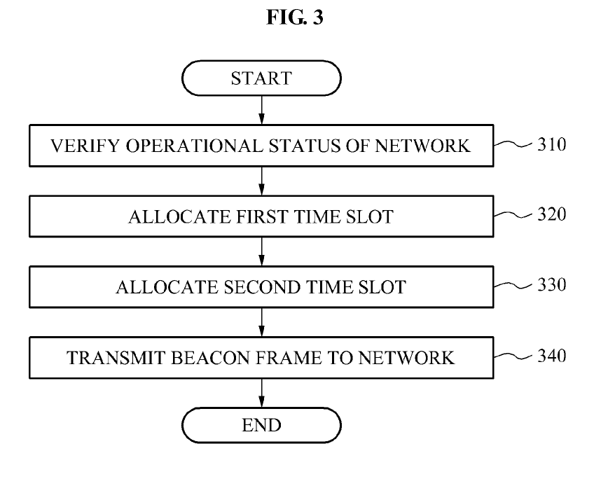

FIG. 3 is a flowchart illustrating a communication method of an AP in a WLAN system according to an embodiment of the present invention.

Referring to FIG. 3, in operation 310, the AP may verify an operational status of a network. For example, the operational status of the network may be a distribution status of the STAs of FIG. 2. In this instance, the network may refer to a WLAN supporting a first bandwidth and a second bandwidth two times greater than the first bandwidth.

In operation 320, the AP may allocate a first time slot in which a transmission of a frame with a bandwidth of at least the first bandwidth is allowed, based on the operational status of the network.

In operation 330, the AP may allocate a second time slot in which a transmission of a frame with a bandwidth of at least the second bandwidth is allowed. Subsequently, the AP may transmit a beacon frame to the network.

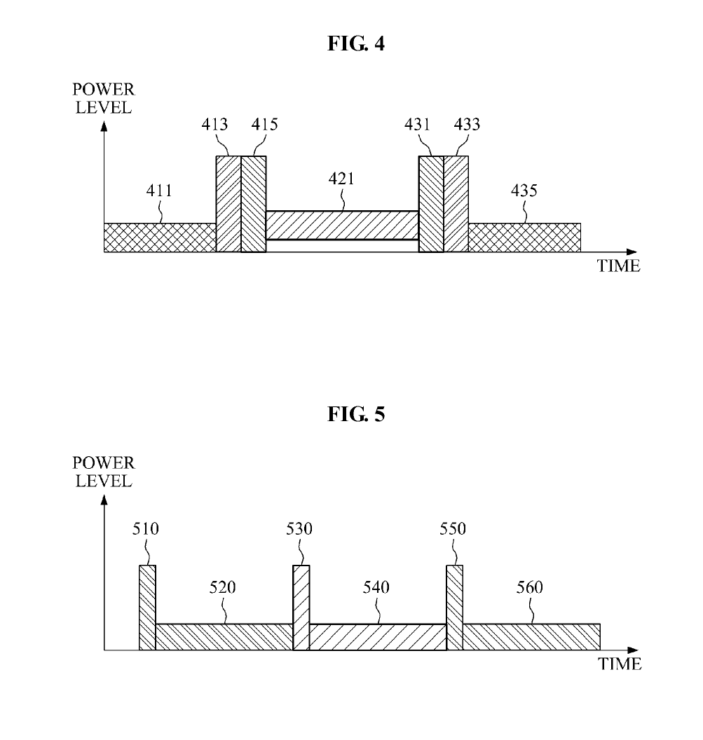

Hereinafter, various schemes for supporting a bandwidth of at least 2 MHz based on the bandwidth of 2 MHz as a reference bandwidth, and obtaining a period of time for transmitting a 1 MHz frame during a predetermined period of time with reference to FIGS. 4 through 6.

FIGS. 4 through 8 are diagrams illustrating various methods of allocating a plurality of basic bandwidths.

Referring to FIG. 4, allocating the first time slot in operation 320 of FIG. 3 may include restricting a channel access of STAs transmitting a frame with a bandwidth at least the second bandwidth using the second bandwidth frame, and providing notification of a start of the first time slot using the first bandwidth frame.

Allocating the second time slot in operation 330 of FIG. 3 may include providing notification of a termination of the first time slot using the first bandwidth frame, and providing notification of a start of the first time slot using the second bandwidth frame.

For example, a transmission of a frame of a bandwidth of 1 MHz may be restricted during a time period 411 for transmitting a bandwidth of at least 2 MHz. When a network allocation vector (NAV) is set for the transmission of the frame with the bandwidth of 1 MHz, an STA may not transmit the frame with the bandwidth of 1 MHz.

In order to allow the transmission of the frame with the bandwidth of 1 MHz, a clear to send (CTS)-to-self frame 413 may be transmitted using a bandwidth of 2 MHz, thereby blocking a channel access of an STA performing a transmission of a bandwidth of at least 2 MHz. When an NAV is set for the transmission of a frame with the bandwidth of at least 2 MHz, the STA may not transmit the frame with the bandwidth of 2 MHz.

The NAV previously set for the transmission of the frame with the bandwidth of 1 MHz may be reset by a contention free (CF)-end frame 415 transmitted using the bandwidth of 1 MHz, and a first time slot 421 in which initiating a transmission of the frame with the bandwidth of 1 MHz may be allowed.

The AP may block a frame transmission of an STA transmitting the bandwidth of 1 MHz to a CTS-to-self frame 431 so as to terminate a transmission of the bandwidth of 1 MHz. Also, the AP may allocate a second time slot in which a frame with the bandwidth of at least 2 MHz is transmitted, to a CF-end frame 433 with the bandwidth of 2 MHz.

Referring to FIG. 5, in operation 320, allocating the first time slot may include allocating a subsequent time slot 540 of a first beacon frame 530 using the first beacon frame 530 with the first bandwidth.

In operation 330, allocating the second time slot may include allocating subsequent time slots 520 and 560 of second beacon frames 510 and 550 to the second time slot using the second beacon frames 510 and 550.

In this instance, a frame being transmitted in the first time slot may be a first basic frame using the first bandwidth or a duplication mode frame generated based on the first basic frame.

In addition, a frame being transmitted in the second time slot may be a second basic frame using the second bandwidth or a duplication mode frame generated based on the second basic frame.

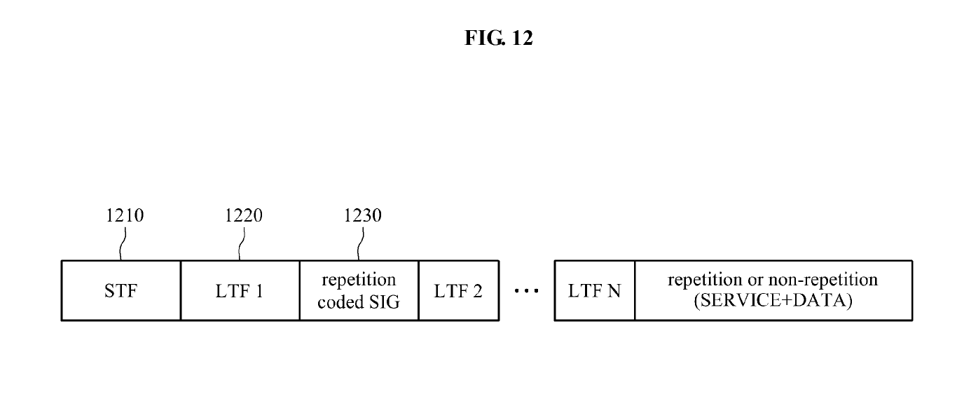

Descriptions about the duplication mode frame will be provided with reference to FIGS. 12 through 15.

Referring back to FIG. 5, the AP may allocate the subsequent time slot 520 in which transmission of a frame with a bandwidth of at least 2 MHz is allowed to the second beacon frame 510 with a bandwidth of 2 MHz through the first beacon frame 530 corresponding to a subsequent beacon frame. Also, the AP may allocate the subsequent time slot 540 in which a frame with all bandwidths including 1 MHz is allowed to be transmitted, after the first beacon frame 530 with a bandwidth of 1 MHz.

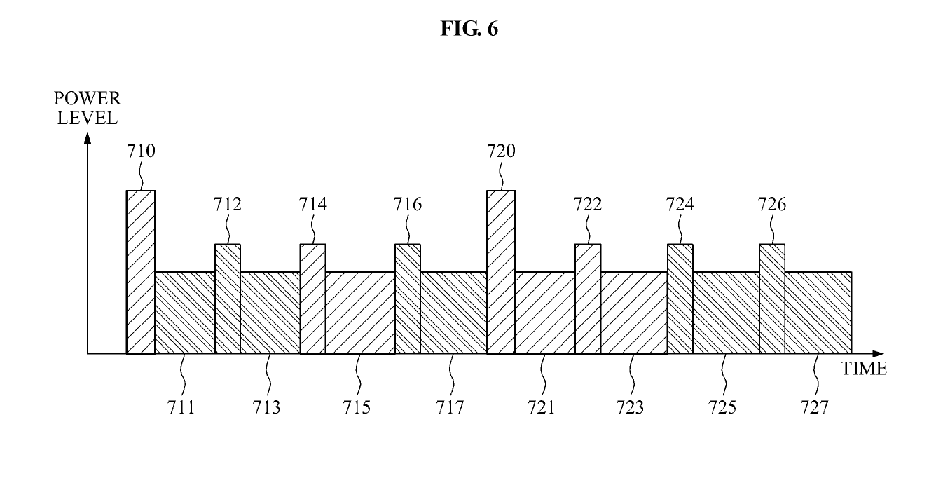

Referring to FIG. 6, in operation 320 of FIG. 3, the first time slot may be allocated by “a short beacon frame using the first bandwidth” transmitted during a transmission interval of a full beacon frame including all control information.

In operation 330 of FIG. 3, the second time slot may be allocated by “a short beacon frame using the second bandwidth” transmitted during the transmission interval of the full beacon.

For example, in FIG. 6, a 1 MHz full beacon frame 610 may be a full beacon transmitted using the bandwidth of 1 MHz, and a 2 MHz full beacon frame 620 may be a full beacon transmitted using the bandwidth of 2 MHz. A short beacon may refer to a beacon including a portion of information included in the full beacon frame.

As described in FIG. 6, in an environment in which full beacons and short beacons are present, 1 MHz short beacon frames or 2 MHz short beacon frames may be transmitted after the 1 MHz full beacon frame 610, and 2 MHz short beacon frames may be transmitted after the 2 MHz full beacon frame 620.

In FIG. 6, a short beacon frame 614 may be transmitted using the bandwidth of 1 MHz, and short beacon frames 612, 616, 622, 624, and 626 may be transmitted using the bandwidth of 2 MHz.

In FIG. 6, time slots 611 and 615 may refer to a time slot in which a transmission of a 1 MHz bandwidth frame or a duplication mode frame generated based on the 1 MHz bandwidth frame is allowed.

In FIG. 6, time slots 613, 617, 621, 623, 625, and 627 may refer to a time slot in which a transmission of a 2 MHz bandwidth frame or a duplication mode frame generated based on the 2 MHz bandwidth frame is allowed.

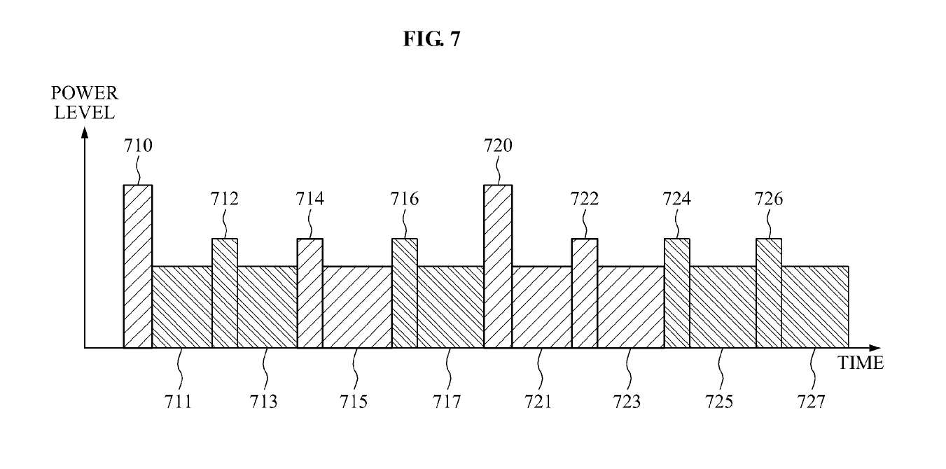

Referring to FIG. 7, when all STAs receive a full beacon, the full beacon may be transmitted using the bandwidth of 1 MHz.

In this instance, a network may be set to transmit 1 MHz short beacon frames 714 and 722, or 2 MHz short beacon frames 712, 716, 724, and 726, after 1 MHz full beacon frames 710 and 720. Also, a subsequent time slot of a beacon frame may set transmission restrictions as described in FIG. 4.

For example, time slots 715, 721, and 723 in which a 1 MHz bandwidth frame or a duplication mode frame generated based on the 1 MHz bandwidth frame may be allocated.

In addition, time slots 711, 713, 717, 725, and 727 in which a 2 MHz bandwidth frame or a duplication mode frame generated based on the 2 MHz bandwidth frame may be allocated.

As described in FIG. 6 and FIG. 7, full beacon frames including the 1 MHz full beacon frame 610, the 2 MHz full beacon frame 620, and the 1 MHz full beacon frames 710 and 720 may be transmitted using the bandwidth of 1 MHz or the bandwidth of 2 MHz. Also, the first time slot or the second time slot may be allocated to subsequent time slots including the time slots 611, 621 711, and 721 of the full beacon frames including the 1 MHz full beacon frame 610, the 2 MHz full beacon frame 620, and the 1 MHz full beacon frames 710 and 720.

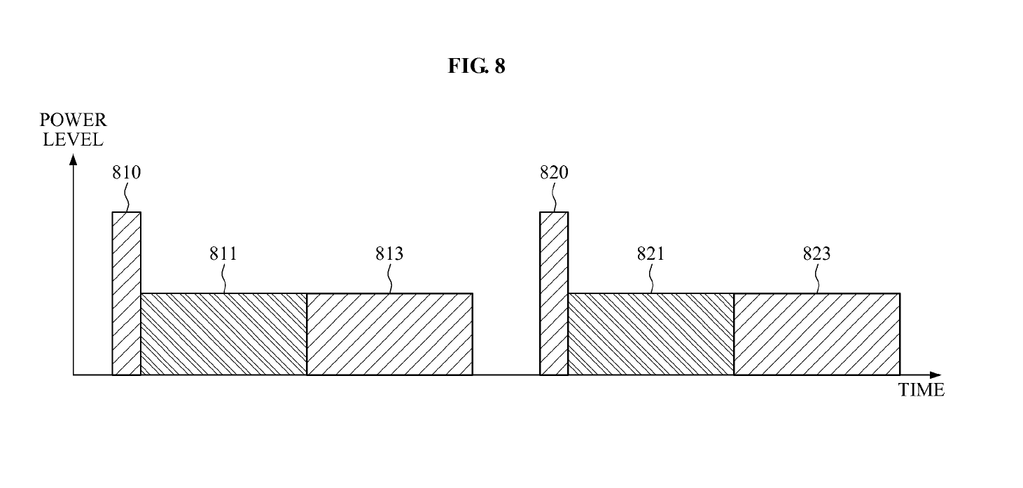

Referring to FIG. 8, the method described in FIG. 3 may also include transmitting, to the network, a beacon frame in which a first restricted access window (RAW) including information associated with the first time slot and a second RAW including information associated with the second time slot is included.

Here, the RAW may refer to a concept of distinguishing STAs allowed to use a channel in a predetermined period of time.

For example, the AP may distinguish transmission intervals 811 and 821 of a frame with a bandwidth of at least 2 MHz, and transmission intervals 813 and 823 of a frame with a bandwidth of at least 1 MHz, thereby allocating the distinguished transmission intervals.

In this instance, all STAs under a communication coverage may receive the RAW. Thus, the beacon frame in which the first RAW and the second RAW is included may be transmitted using a bandwidth corresponding to a relatively long transmission distance, between the first bandwidth and the second bandwidth.

In addition, the first RAW and the second RAW may be distinguished by a more detailed form in order to be allocated.

In FIG. 8, beacons 810 and 820 transmitted using the bandwidth of 1 MHz may include a start time and a termination time of a transmission of a frame with the bandwidth of at least 2 MHz. Also, the beacons 810 and 820 may include information associated with a start time and a termination time at which a transmission of the 1 MHz bandwidth frame or a duplication mode frame generated based on the 1 MHz bandwidth frame is allowed.

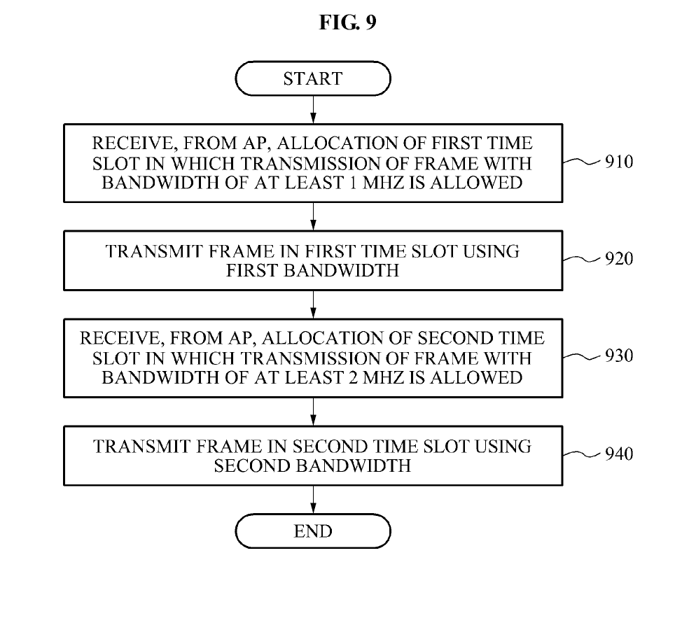

FIG. 9 is a flowchart illustrating a communication method of a station (STA) in a WLAN system according to an embodiment of the present invention.

Referring to FIG. 9, in operation 910, an STA may receive, from an AP, allocation of a first time slot in which a transmission of a frame with a bandwidth of at least 1 MHz is allowed.

In operation 920, the STA may transmit a frame in the first time slot using the first bandwidth. In this instance, the frame transmitted in the first time slot may be a first basic frame using the first bandwidth or a duplication mode frame generated based on the first basic frame.

In operation 930, the STA may receive, from the AP, allocation of a second time slot in which a transmission of a frame with a bandwidth of at least 2 MHz is allowed.

In operation 940, the STA may transmit a frame in the second time slot using the second bandwidth. In this instance, the frame transmitted in the second time slot may be a second basic frame using the second bandwidth or a duplication mode frame generated based on the second basic frame.

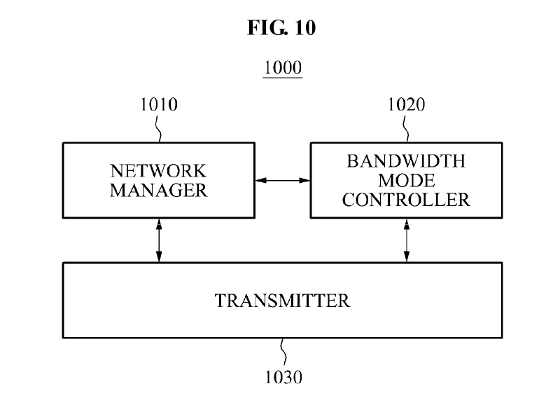

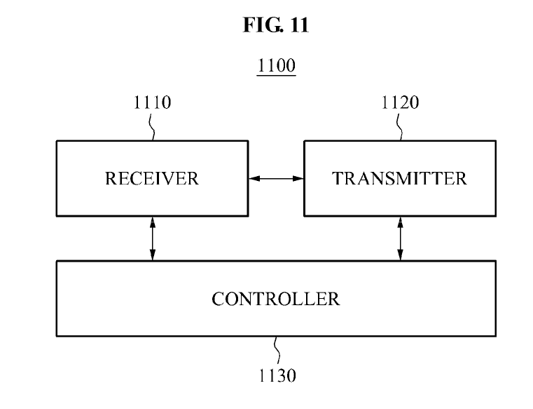

FIG. 10 is a diagram illustrating a configuration of an AP in a WLAN system according to an embodiment of the present invention.

Referring to FIG. 10, an AP 1000 may be used to implement the method described in FIG. 3, and allocate the time slots of FIGS. 4 through 8.

The AP 1000 may include a network manager 1010, a bandwidth mode controller 1020, and transmitter 1030.

The network manager 1010 may verify an operational status of a network supporting a first bandwidth and a second bandwidth two times greater than the first bandwidth. In this instance, the operational status of the network may be pre-stored information in the AP 1000.

The bandwidth mode controller 1020 may allocate a first time slot in which a transmission of a frame with at least the first bandwidth is allowed and a second time slot in which a transmission of a frame with at least the second bandwidth is allowed, based on the operational status of the network.

The transmitter 1030 may transmit a frame for providing notifications of allocation of the first time slot and allocation of the second time slot.

FIG. 11 is a diagram illustrating a configuration of an STA in a WLAN system according to an embodiment of the present invention.

An STA 1100 may receive a beacon frame from an AP and use a bandwidth of 1 MHz or a bandwidth of 2 MHz based on the time slots of FIGS. 4 through 8.

The STA 1100 may include a receiver 1110, a transmitter 1120, and a controller 1130.

The receiver 1110 may receive, from the AP, a control frame for allocating a first time slot in which a transmission of a frame with at least a first bandwidth is allowed and a control frame for allocating a second time slot in which transmission of a frame with at least a second bandwidth two times greater than the first bandwidth is allowed.

The transmitter 1120 may transmit a frame in the first time slot using the first bandwidth, and transmit a frame in the second time slot using the second bandwidth.

The controller 1130 may control an operation mode of the transmitter 1120 based on the control frame. For example, the controller 1130 may receive the CF-end frame 415 of FIG. 4, and control the transmitter 1120 to use a bandwidth of 1 MHz as a basic bandwidth.

Using the bandwidth of 1 MHz as the basic bandwidth may indicate that transmission of a 1 MHz bandwidth frame or a duplication mode frame generated based on the 1 MHz bandwidth frame is allowed.

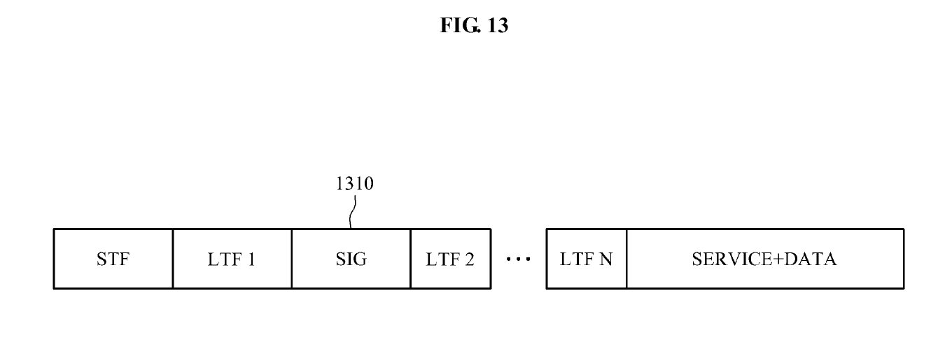

FIG. 12 is a diagram illustrating a frame structure of a first bandwidth of a multi-bandwidth in a wideband WLAN system. FIG. 13 is a diagram illustrating a frame structure of a second bandwidth of a multi-bandwidth in a wideband WLAN system.

Here, the first bandwidth may be a bandwidth of 1 MHz, and the second bandwidth may be a bandwidth of 2 MHz.

Referring to FIG. 12, a 1 MHz mode frame may include a short training field (STF) 1210, a long training field (LTF) 1220, and a repetition coded signal (SIG) field 1230.

A SIG field 1310 of a 2 MHz mode frame may include 48 bits of information including nine bits of length information, four bits of modulation and coding scheme information, and two bits of bandwidth information. The repetition coded SIG field 1230 of the 1 MHz mode frame may include 36 bits of information, aside from the bandwidth information.

A duplication mode frame may be configured in various patterns using the 1 MHz mode frame and the 2 MHz mode frame.

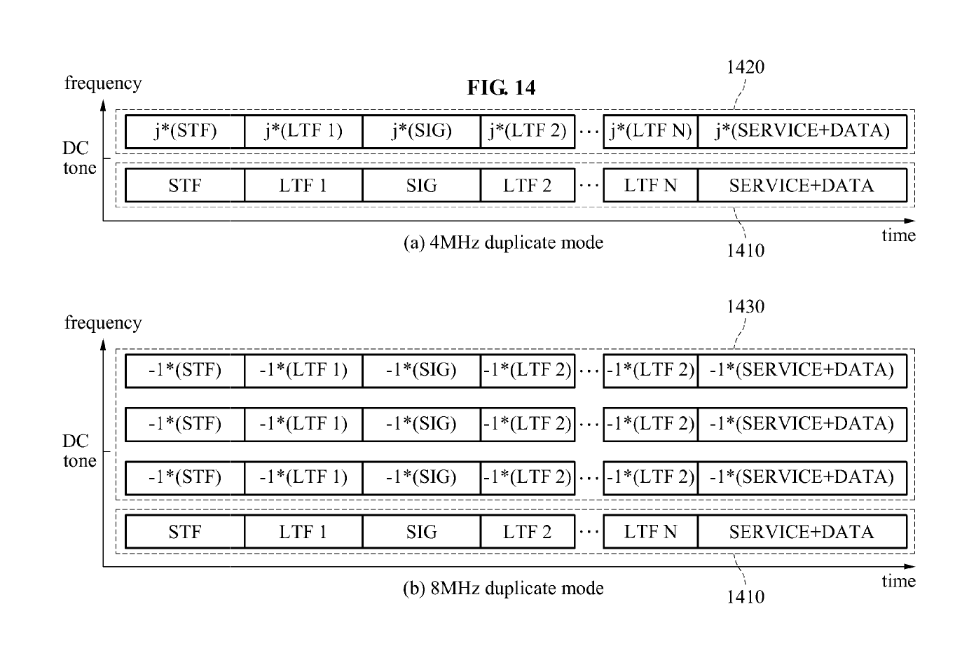

Hereinafter, descriptions about a scheme for configuring the duplication mode frame based on the 2 MHz mode frame will be provided, with reference to FIG. 14, in advance of descriptions about a scheme for configuring the duplication mode frame based on the 1 MHz node frame.

FIG. 14, parts (a) and (b), illustrate an example of configuring a duplication mode frame according to an embodiment of the present invention.

A part (a) of FIG. 14 illustrates a 4 MHz duplication mode frame.

In this instance, the 4 MHz duplication mode frame may include a basic frame 1410 and a duplication frame 1420 having a phase different from a phase of the basic frame 1410 by 90 degrees (°). Referring to FIG. 14, a transmission of a duplication mode frame may indicate transmitting a frame and then phase shifting the same frame by 90° based on a direct current (DC) tone and transmitting the phase-shifted frame, through two bands, respectively.

For example, a process of transmitting the duplication mode frame may include an operation of transmitting a basic frame through a first band and simultaneously transmitting a duplication frame through a second band.

Accordingly, a reception end receiving a duplication mode frame may perform demodulation by receiving a frame received from one of the first band and the second band.

The basic frame 1410 of FIG. 14 may be provided in the same structure as compared to the 2 MHz mode frame of FIG. 4. Thus, the basic frame 1410 may include an STF, an LTF, and an SIG field.

A part (b) of FIG. 14 illustrates an 8 MHz duplication mode frame.

The 8 MHz duplication mode frame may include the basic frame 1410 and three duplication frames 1430 having a phase different from a phase of the basic frame 1410 by 180°.

Four frames included in the 8 MHz duplication mode frame may be simultaneously transmitted through four different bands, respectively.

Accordingly, the reception end receiving the duplication mode frame may perform demodulation or detection by receiving one of the four frames previously transmitted through the four different bands.

Although not shown in FIG. 14, a 16 MHz duplication mode frame may be provided in a structure in which the 8 MHz duplication mode frame is repeated twice at a frequency axis.

The structure of the duplication mode frame of FIG. 14 may be used for a request to send (RTS) and a message transmission of a null data packet (NDP) type short clear to send (CTS) not including a data portion.

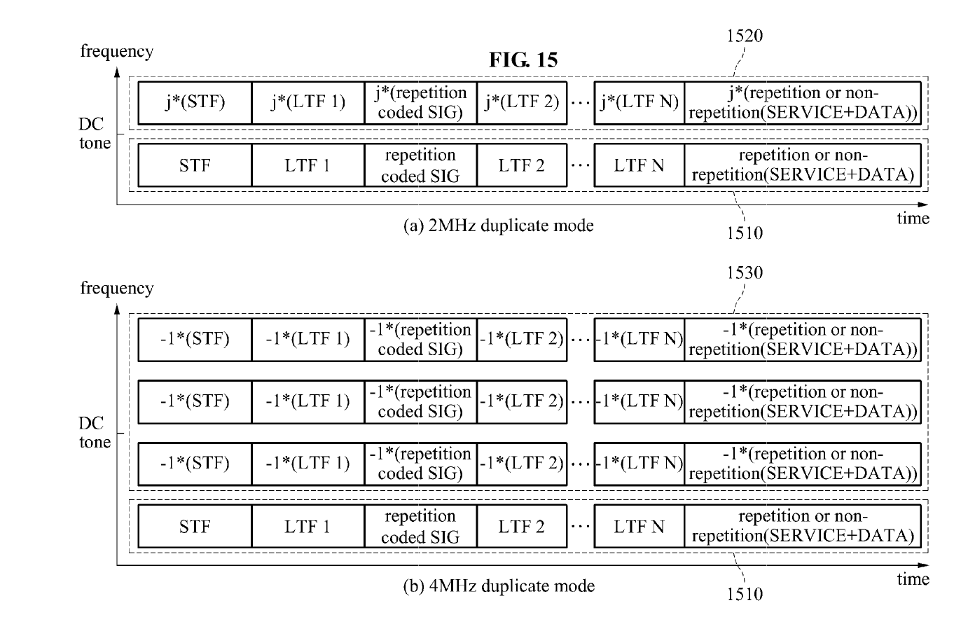

FIG. 15, parts (a) and (b), illustrate an example of configuring a duplication mode frame according to another embodiment of the present invention.

A part (a) of FIG. 15 illustrates a 2 MHz duplication mode frame.

In this instance, the 2 MHz duplication mode frame may include a basic frame 1510 and a duplication frame 1520 having a phase different from a phase of the basic frame 1510 by 90°. Referring to FIG. 15, a transmission of a duplication mode frame may indicate transmitting a frame and then phase shifting the same frame by 90° based on a DC tone and transmitting the phase-shifted frame, through two bands, respectively.

For example, a process of transmitting the duplication mode frame may include an operation of transmitting a basic frame through a third band and simultaneously transmitting a duplication frame through a fourth band.

Accordingly, a reception end receiving a duplication mode frame may perform demodulation by receiving a frame received from one of the second band and the fourth band.

The basic frame 1510 of FIG. 15 may be provided in the same structure as compared to the 1 MHz mode frame of FIG. 12. Thus, the basic frame 1510 may include an STF, an LTF, and an SIG field.

The SIG field of a 1 MHz mode frame may be provided in a structure in which bandwidth information is omitted, with reference to FIG. 12.

When the duplication mode frame is configured based on the bandwidth of 1 MHz, inserting information for defining a bandwidth may be required. For example, bandwidth information may be inserted using a portion of bits among four bits defined as a reserved bit of SIG. In this instance, the bandwidth information may refer to information associated with a bandwidth of a frequency axis for use in the example of FIG. 15. Also, the bandwidth information may be defined using a portion of lower bits of a scrambler sheet included in a service field.

Three bits may be required to divide a bandwidth into 1 MHz, 2 MHz, 4 MHz, 8 MHz, and 16 MHz, thereby defining the divided bandwidths.

Accordingly, the 1 MHz frame structure may be provided in a structure in which multi-bandwidth information is omitted, and a basic frame generated based on the first bandwidth may include the multi-bandwidth information in a signal field or a service field.

A part (b) of FIG. 15 illustrates a 4 MHz duplication mode frame.

The 4 MHz duplication mode frame may include a basic frame 1510 and three duplication frames 1530 having a phase different from a phase of the basic frame 1510 by 180°.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A communication method of an access point (AP) in a wireless local area network (WLAN) system, the method comprising:
verifying an operational status of a network by an AP included in the network supporting a first bandwidth and a second bandwidth two times greater than the first bandwidth;
allocating a first time slot in which a transmission of a frame with at least the first bandwidth is allowed, based on the operational status of the network; and
allocating a second time slot in which a transmission of a frame with at least the second bandwidth is allowed, based on the operational status of the network.

2. The method of claim 1, wherein the allocating of the first time slot comprises restricting a channel access of stations (STAs) transmitting the frame with at least the second bandwidth, using a frame of the second bandwidth, and providing notification of a start of the first time slot using a frame of the first bandwidth.

3. The method of claim 2, wherein the allocating of the second time slot comprises providing notification of a termination of the first time slot using a frame of the first bandwidth, and providing notification of a start of the first time slot using a frame of the first bandwidth.

4. The method of claim 1, wherein the allocating of the first time slot comprises allocating a subsequent time slot of a first beacon frame to the first time slot using the first beacon frame of the first bandwidth, and the allocating of the second slot comprises allocating a subsequent time slot of a second beacon frame to the second time slot using the second beacon frame of the second bandwidth.

5. The method of claim 1, wherein a frame transmitted in the first time slot corresponds to a first basic frame using the first bandwidth or a duplication mode frame generated based on the first basic frame, and a frame transmitted in the second time slot corresponds to a second basic frame using the second time slot or a duplication mode frame generated based on the second basic frame.

6. The method of claim 1, wherein the first time slot is allocated by “a short beacon frame using the first bandwidth” which is transmitted during a transmission interval of a full beacon including all control information, and the second time slot is allocated by “a short beacon frame using the second bandwidth” which is transmitted during the transmission interval of the full beacon.

7. The method of claim 6, wherein the full beacon frame is transmitted using the first bandwidth or the second bandwidth, and the first time slot or the second time slot is allocated to a subsequent time slot of the full beacon frame.

8. The method of claim 1, further comprising:
transmitting a beacon frame in which a first restricted access window (RAW) including information associated with the first time slot and a second RAW including information associated with the second time slot are included.

9. The method of claim 8, wherein the beacon frame in which the first RAW and the second RAW are included is transmitted using a bandwidth corresponding to a relatively long transmission distance, between the first bandwidth and the second bandwidth.

10. A communication method of a station (STA) in a wireless local area network (WLAN) system, the method comprising:
receiving allocation of a first time slot in which a transmission of a frame with at least a first bandwidth is allowed, from an access point (AP) of a network supporting the first bandwidth and a second bandwidth two times greater than the first bandwidth;
transmitting a frame in the first time slot using the first bandwidth;
receiving, from the AP, allocation of a second time slot in which a transmission of a frame with at least the second bandwidth is allowed; and
transmitting a frame in the second time slot using the second bandwidth,
wherein the frame transmitted in the first time slot corresponds to a first basic frame using the first bandwidth or a duplication mode frame generated based on the first basic frame, and the frame transmitted in the second time slot corresponds to a second basic frame using the second bandwidth or a duplication mode frame generated based on the second basic frame.

11. An access point (AP) of a wireless local area network (WLAN) system comprising:
a network manager to verify an operational status of a network supporting a first bandwidth and a second bandwidth two times greater than the first bandwidth;
a bandwidth mode controller to allocate a first time slot in which a transmission of a frame with at least the first bandwidth is allowed, and allocate a second time slot in which a transmission of a frame with at least the second bandwidth is allowed, based on the operational status of the network; and
a transmitter to transmit a frame for providing notification of allocation of the first time slot and allocation of the second time slot.

12. A station (STA) of a wireless local area network (WLAN) system comprising:
a receiver to receive, from an access point (AP), a control frame for allocating a first time slot in which a transmission of a frame with at least a first bandwidth is allowed, and a control frame for allocating a second time slot in which a transmission of a frame with at least a second bandwidth two times greater than the first bandwidth is allowed;
a transmitter to transmit a frame in the first time slot using the first bandwidth, and transmit a frame in the second time slot using the second bandwidth; and
a controller to control an operation mode of the transmitter based on the control frame.
